(19) United States
(12) Patent Application Publication
(10) Pub. No.: US 2025/0044581 A1
(43) Pub. Date: Feb. 6, 2025

(54) OPTICAL SCANNING DEVICE AND IMAGE FORMING APPARATUS INCLUDING THE OPTICAL SCANNING DEVICE

(71) Applicant: KYOCERA Document Solutions Inc., Osaka (JP)

(72) Inventor: Takaaki MURASE, Osaka (JP)

(73) Assignee: KYOCERA Document Solutions Inc., Osaka (JP)

(21) Appl. No.: 18/785,377

(22) Filed: Jul. 26, 2024

(30) Foreign Application Priority Data
Jul. 31, 2023 (JP) 2023-124212

(51) Int. Cl. G02B 26/12; G03G 15/04

(52) U.S. Cl. CPC G02B 26/123; G03G 15/04072

(57) ABSTRACT

The optical scanning device includes a light source unit. The light source unit has a plurality of light-emitting modules for each emitting a laser beam. The light-emitting modules are placed in array in an up/down direction between neighboring ones of protruding portions. An outermost diameter of a bracket in a region interposed between the protruding portions of the light-emitting modules placed on an upper side is larger than an outermost diameter of the bracket in a region interposed between the protruding portions of the light-emitting modules placed on a lower side. A width between the protruding portions in a region where the light-emitting modules placed on the upper side are interposed therebetween is larger than a width between the protruding portions in a region where the light-emitting modules placed on the lower side are interposed therebetween.

### INCORPORATION BY REFERENCE

This application is based on and claims the benefit of priority from Japanese Patent Application No. 2023-124212 filed on Jul. 31, 2023, the contents of which are hereby incorporated by reference.

### BACKGROUND

The present disclosure relates to an optical scanning device for forming a latent image on a scanning-object surface by exposure scanning, as well as copiers, printers, facsimiles, multifunction peripherals, or other image forming apparatuses which include the optical scanning devices.

A conventional optical scanning device includes a light source unit, a polygon mirror, a first scanning lens, a second scanning lens, and a container (optical box). The light source unit has a plurality of disposed light-emitting modules (optical units) for emitting laser light. The polygon mirror, while rotated about a rotational axis extending vertically, reflects laser light emitted from the light source unit to scan a circumferential surface of an image carrier in a main scanning direction. The first scanning lens condenses the laser light reflected by the polygon mirror. The second scanning lens allows the laser light transmitted by the first scanning lens to form an image on the circumferential surface of the image carrier. The container accommodates the light source unit, the polygon mirror, the first scanning lens, and the second scanning lens.

Each light-emitting module includes a light-emitting element, a lens, and a bracket. The light-emitting element emits laser light. The lens converts the laser light emitted from the light-emitting element into a direction generally parallel to the main scanning direction. The bracket, being formed into a cylindrical shape, extends in an emission direction of the laser light while holding the lens inside. The two light-emitting modules are unitized via a fixing member which is fixed to the container.

With the conventional art adopted, there has been a problem that position-adjusting and fixation of the light-emitting modules would involve difficulties in rotating the light-emitting modules circumferentially about the light-emission direction of the laser light or attaining position-adjusting of the modules by tilting those modules in the vertical direction.

In view of the above-described problems, an object of the present disclosure is to provide an optical scanning device capable of stably fixing the light-emitting modules by attaining their positional adjustment, as well as image forming apparatuses including the optical scanning device.

### SUMMARY

In order to achieve the object, a first configuration according to the present disclosure is an optical scanning device which includes a light source unit, a polygon mirror, a first scanning lens, a second scanning lens, and a container unit. The light source unit has a plurality of light-emitting modules for each emitting a laser beam. The polygon mirror is rotated about a rotational axis extending in an up/down direction to reflect the laser beam emitted from the light source unit and make a circumferential surface of an image carrier scanned in a main scanning direction. The first scanning lens condenses the laser beam reflected by the polygon mirror. The second scanning lens makes the laser beam, which has passed through the first scanning lens, form an image on the circumferential surface of the image carrier. The container unit contains the light source unit, the polygon mirror, the first scanning lens, and the second scanning lens. Each of the light-emitting modules includes a light-emitting element for emitting the laser beam, a coupling lens, and a bracket. The coupling lens converts the laser beam emitted from the light-emitting element into a direction generally parallel to the main scanning direction and moreover condensing the laser beam to a sub scanning direction. The bracket extends in an outgoing direction of the laser beam, holds the coupling lens inside, and has a cylindrical shape. The container unit has a bottom wall portion, and a plurality of protruding portions. The bottom wall portion extends in a direction perpendicular to the rotational axis. The protruding portions protrude upward from an upper face of the bottom wall portion. The light-emitting modules are placed in array in the up/down direction between neighboring ones of the protruding portions. An outermost diameter of the bracket in a region interposed between the protruding portions of the light-emitting modules placed on an upper side is larger than an outermost diameter of the bracket in a region interposed between the protruding portions of the light-emitting modules placed on a lower side. A width between the protruding portions in a region where the light-emitting modules placed on the upper side are interposed therebetween is larger than a width between the protruding portions in a region where the light-emitting modules placed on the lower side are interposed therebetween.

This and other objects of the present disclosure, and the specific benefits obtained according to the present disclosure, will become more apparent from the description of embodiments which follows.

### BRIEF DESCRIPTION OF THE DRAWINGS

FIG. 1 is a schematic sectional view showing a general configuration of an image forming apparatus 100 on which an optical scanning device 5 according to the present disclosure is mounted;

FIG. 2 is a perspective view of the optical scanning device 5 according to one embodiment of the disclosure;

FIG. 3 is a perspective view of the optical scanning device 5 according to one embodiment of the disclosure;

FIG. 4 is a sectional view cut along a line A-A of FIG. 2;

FIG. 5 is a perspective view showing, in enlargement, around a light source unit 46 of the optical scanning device 5 of the disclosure;

FIG. 6 is a perspective view of light-emitting modules 30K, 30Y in the optical scanning device 5 of the disclosure;

FIG. 7 is a perspective view of light-emitting modules 30C, 30M in the optical scanning device 5 of the disclosure;

FIG. 8 is a side sectional view of light-emitting modules 30K, 30Y in the optical scanning device 5 of the disclosure;

FIG. 9 is a side sectional view of light-emitting modules 30C, 30M in the optical scanning device 5 of the disclosure; and

FIG. 10 is a sectional view perpendicular to the main scanning direction of the light source unit 46 in the optical scanning device 5 of the disclosure.

### DETAILED DESCRIPTION

### (1. Configuration of Image Forming Apparatus)

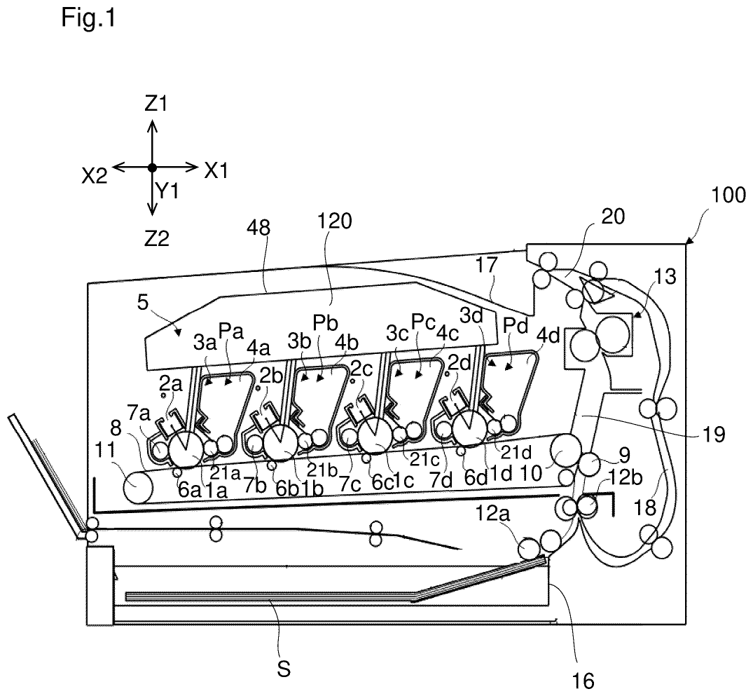

Hereinafter, an embodiment of the present disclosure will be described with reference to the accompanying drawings. FIG. 1 is a schematic sectional view showing a general configuration of an image forming apparatus 100 on which an optical scanning device 5 according to the disclosure is mounted. For explanation's sake, in an installation state (state shown in FIG. 1) in which the image forming apparatus 100 is available, a vertical direction is defined as Z1-Z2 direction. Also, a front/rear direction (Y1-Y2 direction) is defined on an assumption that with a drawing-sheet near-side face of the image forming apparatus 100 shown in FIG. 1 is assumed as a front face (frontage). Further, a left/right direction (X1-X2 direction) is defined by referencing a frontage of the image forming apparatus 100 in its installation state. In this embodiment, the left/right direction (X1-X2 direction) is perpendicular to the up/down direction (Z1-Z2 direction) and the front/rear direction (Y1-Y2 direction).

The image forming apparatus 100 is a tandem-type color printer. The image forming apparatus 100 includes photosensitive drums 1a to 1d that are rotatable as image carriers. For the photosensitive drums 1a to 1d, a usable material is organic photoconductor (OPC) with an organic photosensitive layer formed, or amorphous silicon with an amorphous silicon photosensitive layer formed, or the like. The photosensitive drums 1a to 1d are tandem-disposed in correspondence to individual colors of yellow, cyan, magenta and black, respectively.

A developing unit 3a, a charging unit 2a, and a cleaning unit 7a are disposed around the photosensitive drum 1a. Similarly, developing units 3b to 3d, charging units 2b to 2d, and cleaning units 7b to 7d are disposed around the photosensitive drums 1b to 1d, respectively. Further, an optical scanning device 5 is placed at an upward Z1 of the developing units 3a to 3d.

The developing units 3a to 3d are placed rightward X1 of the photosensitive drums 1a to 1d, respectively. The developing units 3a to 3d, which are opposed to the photosensitive drums 1a to 1d, feed toner to the photosensitive drums 1a to 1d, respectively. The developing units 3a to 3d include containers 4a to 4d, in which individual-color toner of magenta, cyan, yellow, and black is contained.

The charging units 2a to 2d are placed upstream of the developing units 3a to 3d in a rotational direction of the photosensitive drums 1a to 1d, respectively, and are opposed to surfaces of the photosensitive drums 1a to 1d, respectively. The charging units 2a to 2d electrically charge uniformly the surfaces of the photosensitive drums 1a to 1d, respectively.

The optical scanning device 5, in this embodiment, is placed upward Z1 of the photosensitive drums 1a to 1d. Based on image data such as characters and patterns inputted from a personal computer or the like to an image input unit, the optical scanning device 5 emits light to (optically scans) the surfaces of the photosensitive drums 1a to 1d uniformly charged by the charging units 2a to 2d, respectively. As a result, electrostatic latent images are formed on the surfaces of the photosensitive drums 1a to 1d.

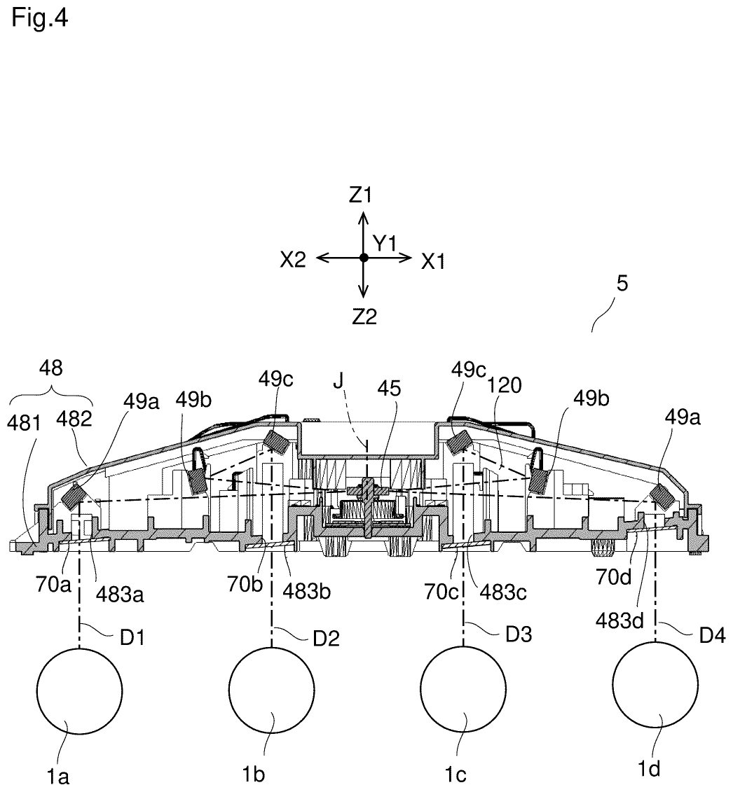

An enclosure 48 of the optical scanning device 5, which is a resin molded product, includes a container portion 481 with one surface (upper surface in this embodiment) opened, and a lid portion 482 (see FIG. 4). The container portion 481 internally contains an scanning optical system. The container portion 481 will be detailed later.

Laser beams D1 to D4 are emitted to the surfaces of the photosensitive drums 1a to 1d from a downstream side of the charging units 2a to 2d in the rotational direction of the photosensitive drums 1a to 1d, respectively. As a result, electrostatic latent images are formed on the surfaces of the photosensitive drums 1a to 1d, respectively. These electrostatic latent images are developed into toner images by the developing units 3a to 3d, respectively. It is noted that the optical scanning device 5 will be detailed later.

An endless intermediate transfer belt 8 is stretched over a driving roller 10 and a driven roller 11. As the driving roller 10 is rotated by a motor (not shown), the intermediate transfer belt 8 is driven into clockwise circulation as in FIG. 1.

The photosensitive drums 1a to 1d are arrayed upward Z1 of the intermediate transfer belt 8 so as to be next to one another along a conveyance direction. Also, the photosensitive drums 1a to 1d are each in contact with the intermediate transfer belt 8.

Primary transfer rollers 6a to 6d are opposed to the photosensitive drums 1a to 1d, respectively, with the intermediate transfer belt 8 pinched therebetween. The primary transfer rollers 6a to 6d are set into pressure contact with the intermediate transfer belt 8 to form primary transfer units in cooperation with the photosensitive drums 1a to 1d, respectively. In these primary transfer units, toner images are transferred onto the intermediate transfer belt 8.

In more detail, a primary transfer voltage is applied to the primary transfer rollers 6a to 6d, so that toner images of the photosensitive drums 1a to 1d are transferred successively to the intermediate transfer belt 8 at specified timings. As a result, a full-color toner image in which four-color toner images of magenta, cyan, yellow, and black have been superimposed together with a specified positional relation is formed on the surface of the intermediate transfer belt 8.

A secondary transfer roller 9 is opposed to the driving roller 10 with the intermediate transfer belt 8 pinched therebetween. The secondary transfer roller 9 is set into pressure contact with the intermediate transfer belt 8 to form a secondary transfer unit in cooperation with the driving roller 10. In this secondary transfer unit, a secondary transfer voltage is applied to the secondary transfer roller 9, so that the toner image on the surface of the intermediate transfer belt 8 is transferred onto a paper sheet S. After the transfer of the toner image, a belt cleaning unit (not shown) cleans up toner remaining on the intermediate transfer belt 8.

A sheet feed cassette 16 is placed downward in the image forming apparatus 100. The sheet feed cassette 16 is capable of accommodating a plurality of sheets S. A sheet conveyance path 19 is placed rightward X1 of the sheet feed cassette 16.

The sheet conveyance path 19 is for conveyance of the sheet S pulled out from the sheet feed cassette 16 to the secondary transfer unit. Right upward in the image forming apparatus 100, a fixing unit 13 and a sheet conveyance path 20 are placed. The fixing unit 13 executes fixing process for the sheet S having an image formed thereon. The sheet conveyance path 20 is for conveyance of the sheet over the fixing process to a sheet discharge unit 17.

Sheets S accommodated in the sheet feed cassette 16 are pulled out sheet by sheet by a pickup roller 12a toward the sheet conveyance path 19.

A registration roller pair 12b conveys the sheet S to the secondary transfer unit at proper timings for image formation operation in the intermediate transfer belt 8 and for sheet feed operation to the secondary transfer unit. Onto the sheet S conveyed to the secondary transfer unit, the full-color toner image on the intermediate transfer belt 8 is secondarily transferred by the secondary transfer roller 9 to which the secondary transfer voltage has been applied. The sheet S to which the full-color toner image has been transferred is conveyed to the fixing unit 13.

The fixing unit 13 includes a fixing belt to be heated by a heater, a fixing roller inscribed in the fixing belt, a pressure roller put into pressure contact with the fixing roller with the fixing belt pinched therebetween, or the like. The fixing unit 13 heats and pressurizes the sheet S having the toner image transferred thereto. As a result, the fixing process is fulfilled. The sheet S having the toner image fixed at the fixing unit 13 is reversed, as needed, between front and back side by a sheet conveyance path 18. Thereafter, the sheet S is conveyed to the secondary transfer unit again via the registration roller pair 12b, and subsequently a new toner image is secondarily transferred to the back side of the sheet S by the secondary transfer roller 9, followed by fixation in the fixing unit 13. The sheet S with the toner images fixed thereon is discharged to the sheet discharge unit 17 via the sheet conveyance path 20.

### (2. Configuration of Optical Scanning Device)

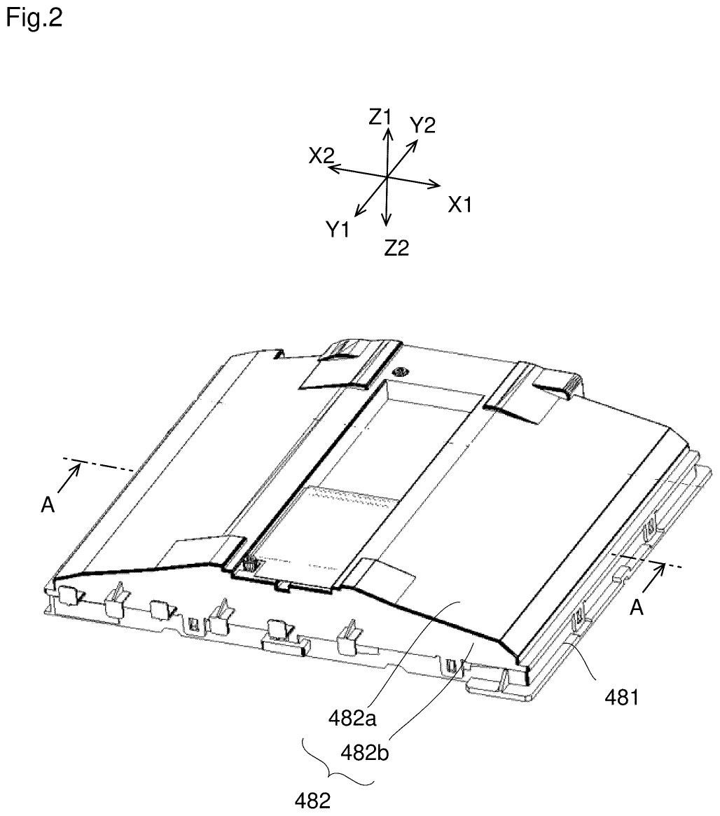

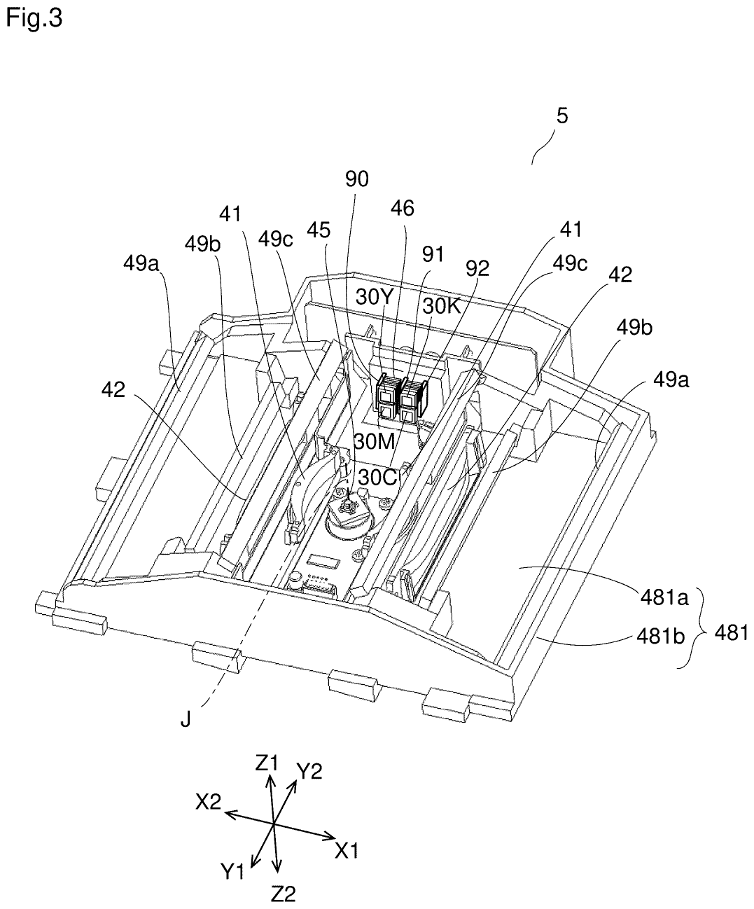

FIGS. 2 and 3 are perspective views of the optical scanning device 5, where FIG. 3 shows a state in which the lid portion 482 has been removed. FIG. 4 is a sectional view cut along a line A-A of FIG. 2. Part of FIG. 4 schematically shows a configuration of individual members, and does not strictly show shapes and positional relations of those members. FIG. 4 depicts neither a first scanning lens 41 nor a second scanning lens 42.

Hereinafter, the terms ‘main scanning direction’ (Y1-Y2 direction) refers to a longitudinal direction of reflecting mirrors 49a to 49c. Also, the terms ‘main scanning direction’ (Y1-Y2 direction) is identical to a direction in which the rotational axes of the photosensitive drums 1a to 1d extend, as well as to a front/rear direction of the image forming apparatus 100. The terms ‘sub scanning direction’ (Z1-Z2 direction) refers to a direction parallel to a rotational axis J of a polygon mirror 45 and identical to an up/down direction of the image forming apparatus 100. Also, the terms ‘left/right direction’ (X1-X2 direction) is a direction perpendicular to the main scanning direction (Y1-Y2 direction) and the sub scanning direction (Z1-Z2 direction), and identical to a juxtapositional direction of the reflecting mirrors 49a to 49c.

The optical scanning device 5 outputs (emits) a plurality (four in this embodiment) of laser beams D1 to D4 modulated in response to image signals to the photosensitive drums 1a to 1d to expose to light the surfaces of the photosensitive drums 1a to 1d, so that electrostatic latent images with charged level attenuated are formed.

The optical scanning device 5 includes a light source unit 46, the polygon mirror 45, a pair of first scanning lenses 41, a pair of second scanning lenses 42, a pair of reflecting mirrors 49a, 49b, 49c, and an enclosure 48 (container 481).

The enclosure 48 includes the container portion 481 and the lid portion 482. The container portion 481 is formed into a generally quadrangle as viewed in a top view. The container portion 481 contains the light source unit 46, the polygon mirror 45, the pair of first scanning lenses 41, the pair of second scanning lenses 42, and the pair of reflecting mirrors 49a, 49b, 49c.

The container portion 481 has a bottom wall portion 481a, a peripheral wall portion 481b, and a plurality of protruding portions 90, 91, 92. The bottom wall portion 481a extends in a direction perpendicular to the rotational axis J of the polygon mirror 45. In the bottom wall portion 481a, outgoing ports 483a to 483d extending through in the up/down direction are formed (see FIG. 4). The outgoing ports 483a to 483d extend in the main scanning direction (Y1-Y2 direction). The laser beams D1 to D4 emitted from the scanning optical system are emitted outward of the enclosure 48 via the outgoing ports 483a to 483d, going incident on the photosensitive drums 1a to 1d, respectively and correspondingly. The outgoing ports 483a to 483d are covered with dustproof glasses 70a to 70d, respectively. As a result, dust can be prevented from intruding inside the enclosure 48.

The protruding portions 90, 91, 92 protrude upward from the upper face of the bottom wall portion 481a. The protruding portions 90, 91, 92 hold the light source unit 46. Shape of the protruding portions 90, 91, 92 will be detailed later.

The peripheral wall portion 481b, which extends upward from outer peripheral portion of the bottom wall portion 481a, internally encloses the light source unit 46, the polygon mirror 45, the pair of first scanning lenses 41, the pair of second scanning lenses 42, the pair of reflecting mirrors 49a, 49b, 49c from sideward.

The lid portion 482 has a top surface portion 482a and a peripheral surface portion 482b. The top surface portion 482a covers an opened upper face of the container portion 481. The peripheral surface portion 482b, extending downward from an outer peripheral portion of the top surface portion 482a, covers part of the peripheral wall portion 481b from radially outward.

The light source unit 46 includes a plurality of light-emitting modules 30Y, 30C, 30M, 30K for emitting laser light. The light-emitting modules 30Y, 30C, 30M, 30K output laser beams D1 to D4 corresponding to the individual colors of Y (yellow), C (cyan), M (magenta), K (magenta), respectively. The laser beams D1 to D4 emitted from the light-emitting modules 30Y, 30C, 30M, 30K, respectively, are applied to the polygon mirror 45. The laser beams D1 to D4 form line images in vicinities of a deflection plane of the polygon mirror 45.

The polygon mirror 45 is rotated about the rotational axis J extending in the up/down direction (Z1-Z2 direction), so as to reflect the laser beams D1 to D4 emitted from the light source unit 46, thereby making the peripheral surfaces of the photosensitive drums (image carriers) 1a to 1d scanned in the main scanning direction.

The polygon mirror 45 is composed of a plurality of reflecting surfaces. In this embodiment, the polygon mirror 45 is a polyhedral mirror formed into a quadrangular prism shape. The laser beams D1, D2 having been incident on the polygon mirror 45 are subjected to deflective scanning by any arbitrary reflecting surface that is driven into rotation, then being reflected leftward (X2 direction) by the reflecting surface of the polygon mirror 45, and led to the first scanning lens 41 and the second scanning lens 42. Meanwhile, the laser beams D3, D4 having been incident on the polygon mirror 45 are subjected to deflective scanning by any arbitrary reflecting surface that is driven into rotation, then being reflected rightward (X1 direction) by the reflecting surface of the polygon mirror 45, and led to the first scanning lens 41 and the second scanning lens 42 (see FIG. 4).

The second scanning lens 42 is placed downstream of the first scanning lens 41 in optical paths of the laser beams D1 to D4.

The first scanning lens 41 is a lens having a distortion (fθ characteristic) and also an elongated lens extending along the main scanning direction (Y1-Y2 direction). The first scanning lens 41 condenses the laser beams D1 to D4 reflected by the deflection plane of the polygon mirror 45.

The second scanning lens 42, like the first scanning lens 41, is a lens having a distortion (fθ characteristic) and also an elongated lens extending along the main scanning direction (Y1-Y2 direction). The second scanning lens 42 condenses the laser beams D1 to D4 having passed through the first scanning lens 41, thereby forming images on the scanning-object surfaces of the photosensitive drums 1a to 1d.

The pair of reflecting mirrors 49a reflect the laser beams D1, D4, respectively. The pair of reflecting mirrors 49b and the pair of reflecting mirrors 49c reflect the laser beams D2, D3, respectively.

The laser beam D1 condensed by the first scanning lens 41 and the second scanning lens 42 is reflected by the reflecting mirrors 49a so as to form an image on the scanning-object surface of the photosensitive drum 1a. The laser beam D4 condensed by the first scanning lens 41 and the second scanning lens 42 is reflected by the reflecting mirrors 49a so as to form an image on the scanning-object surface of the photosensitive drum 1d.

The laser beam D2 condensed by the first scanning lens 41 and the second scanning lens 42 is reflected by the reflecting mirrors 49b, 49c so as to form an image on the scanning-object surface of the photosensitive drum 1b. The laser beam D3 condensed by the first scanning lens 41 and the second scanning lens 42 is reflected by the reflecting mirrors 49b, 49c so as to form an image on the scanning-object surface of the photosensitive drum 1c.

The laser beams D1 to D4 deflectively reflected by the polygon mirror 45, passing through the first scanning lens 41 and the second scanning lens 42, are condensed on the scanning-object surfaces of the photosensitive drums 1a to 1d. As a result, beam spots are formed on the scanning-object surfaces of the photosensitive drums 1a to 1d. Also, the laser beams D1 to D4 condensed on the scanning-object surfaces of the photosensitive drums 1a to 1d are subjected to uniform-velocity scanning on the scanning-object surfaces of the photosensitive drums 1a to 1d.

In this case, rotation of the polygon mirror 45 causes the laser beams D1 to D4 to be subjected to scanning of the scanning-object surfaces (peripheral surfaces) of the photosensitive drums (image carriers) 1a to 1d in the main scanning direction (Y1-Y2 direction). Also, rotation of the photosensitive drums 1a to 1d causes the laser beams D1 to D4 to be subjected to scanning in the sub scanning direction (Z1-Z2 direction) to form electrostatic latent images on the surfaces of the photosensitive drums 1a to 1d.

### (3. Configuration of Light Source Unit)

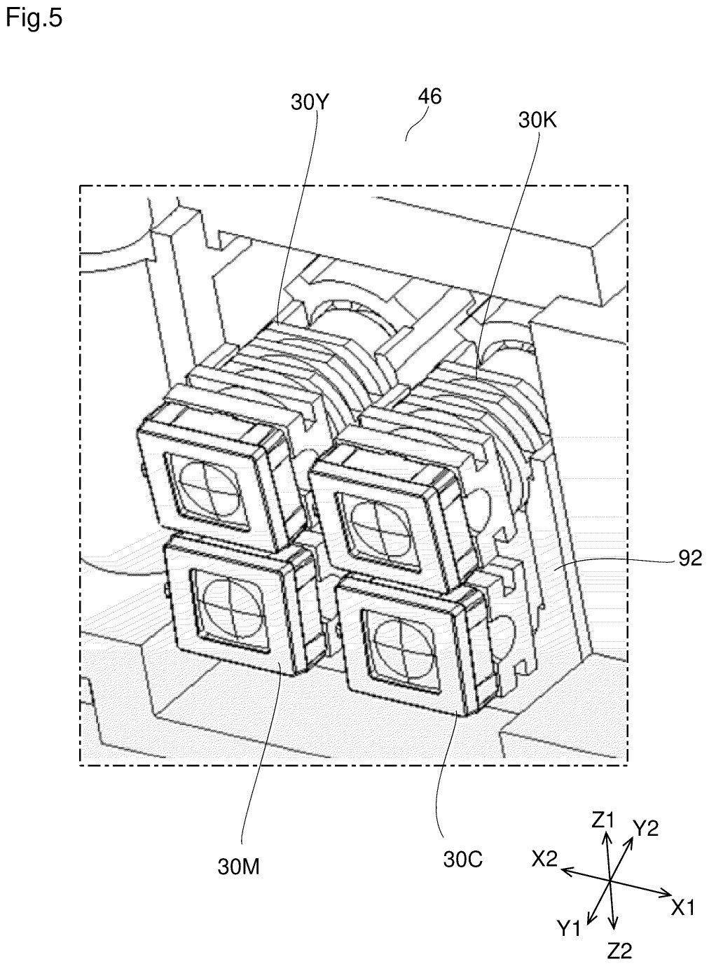

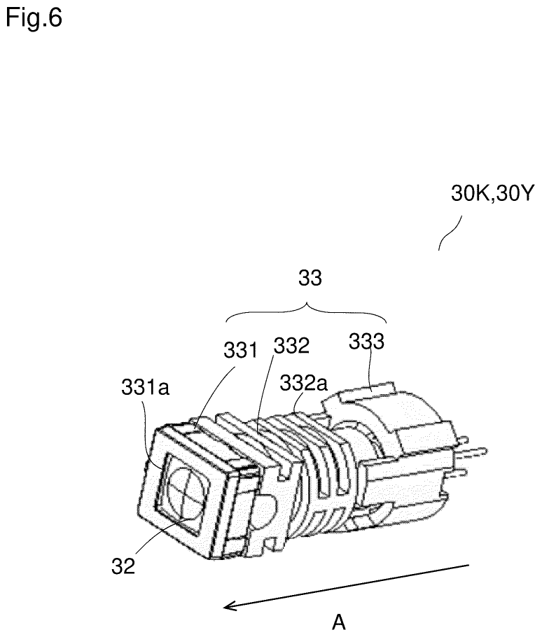

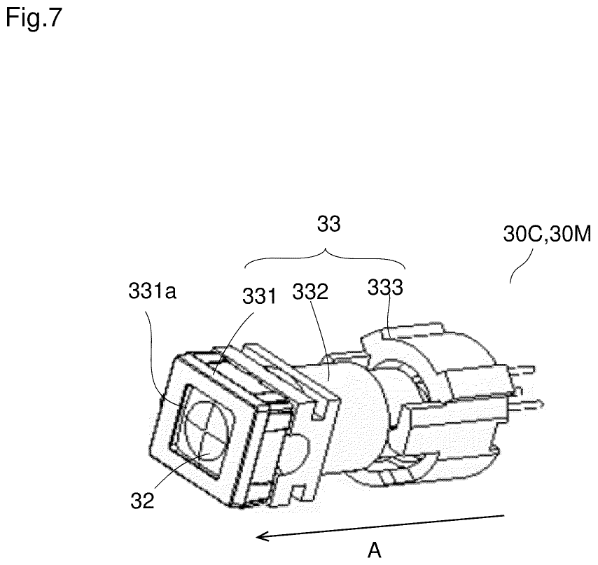

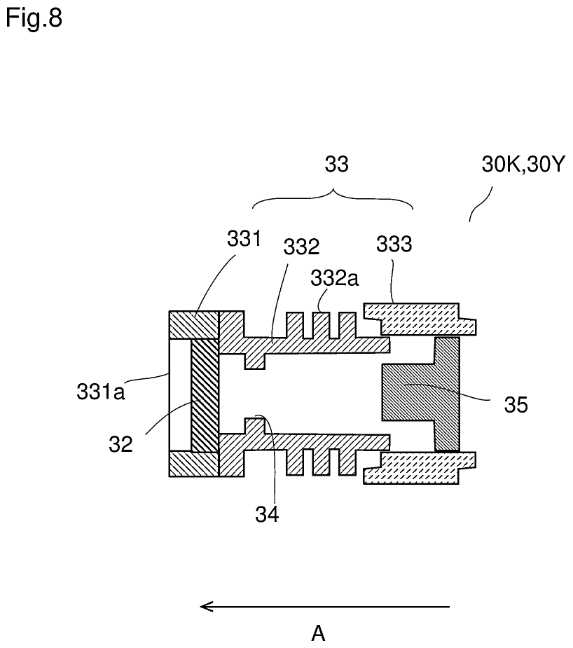

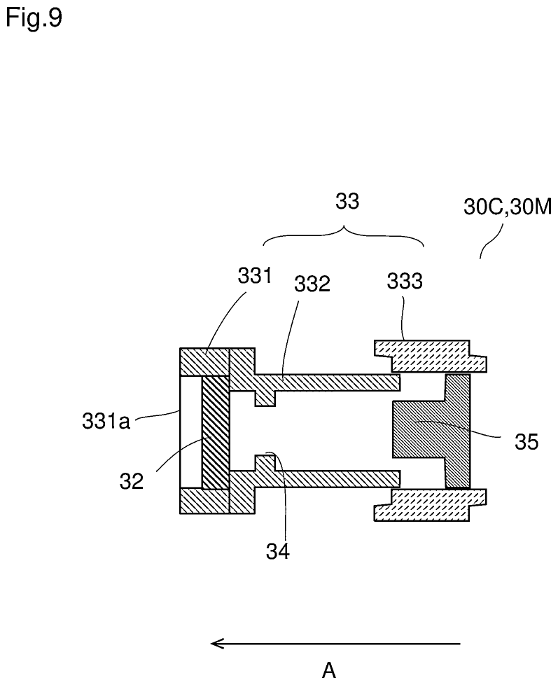

FIG. 5 is a perspective view showing, in enlargement, the light source unit 46. FIG. 6 is a perspective view of the light-emitting modules 30K, 30Y. FIG. 7 is a perspective view of the light-emitting modules 30C, 30M. FIG. 8 is a side sectional view of the light-emitting modules 30K, 30Y. FIG. 9 is a side sectional view of the light-emitting modules 30C, 30M.

The light source unit 46 is composed of the light-emitting modules 30Y, 30C, 30M, 30K. The light-emitting modules 30K, 30C are placed rightward (X1 side) of the rotational axis J as viewed from the polygon mirror 45 in the main scanning direction (Y1-Y2 direction), while the light-emitting module 30C is placed downward (Z2 side) of the light-emitting module 30K. The light-emitting modules 30Y, 30M are placed leftward (X2 side) of the rotational axis J as viewed from the polygon mirror 45 in the main scanning direction (Y1-Y2 direction), while the light-emitting module 30M is placed downward (Z2 side) of the light-emitting module 30Y.

Also, the light-emitting modules 30K, 30Y placed on the upper side, out of the light-emitting modules 30Y, 30C, 30M, 30K, are identical in shape to each other and different therebetween only in color of laser beams emitted from a light-emitting element 35. Further, the light-emitting modules 30C, 30M placed on the lower side are identical in shape to each other and different therebetween only in color of laser beams emitted from the light-emitting element 35. Also, the light-emitting modules 30K, 30Y and the light-emitting modules 30C, 30M are different therebetween only in shape of a bracket 33.

Each of the light-emitting modules 30Y, 30C, 30M, 30K has the light-emitting element 35 that emits any one of the laser beams D1 to D4, a coupling lens 32, and the bracket 33. In this embodiment, the laser beam D1 is emitted from the light-emitting element 35 of the light-emitting module 30K. Also, the laser beam D2 is emitted from the light-emitting element 35 of the light-emitting module 30C. Also, the laser beam D3 is emitted from the light-emitting element 35 of the light-emitting module 30M. Also, the laser beam D4 is emitted from the light-emitting element 35 of the light-emitting module 30Y.

The coupling lens 32 is operative to convert directions of the laser beams D1 to D4 emitted from the light-emitting elements 35, respectively, to generally parallel with the main scanning direction and moreover to make the laser beams D1 to D4 condensed toward the sub scanning direction. As a result of this, the laser beams D1 to D4 form line images in vicinities of the deflective surface of the polygon mirror 45. The coupling lens 32 is, for example, anamorphic-shaped and composed of metal-molded one lens.

The bracket 33, extending in an outgoing direction (A direction) of laser beams, holds the coupling lens inside and has a cylindrical shape. The bracket 33 is composed of a lens holder 331, a laser holder 332, and an element holder 333. The bracket 33 is a resin-molded product, for which lightweight, heat-resistant synthetic resin (e.g., alloy material of ABS resin and PC resin) or the like is preferably usable.

The laser holder 332 includes a throttle portion 34 which extends in the outgoing direction (A direction) of a laser beam and at which the optical path for the laser beam is constricted. The throttle portion 34 allows the laser beam to obtain a desired beam spot diameter.

The lens holder 331 is fixed at the one end of the laser holder 332 in its outgoing direction (A direction), and holds the coupling lens 32 inside. Also, the lens holder 331 has an opening 331a, which allows a laser beam having passed through the coupling lens 32 to be emitted outward of the bracket 33 via the opening 331a.

The element holder 333 is fixed at the other end of the laser holder 332 in its outgoing direction (A direction), and holds the light-emitting element 35 inside. The laser holder 332 and the element holder 333 are fixed via adhesive at specified positions with their directions three-dimensionally changed, respectively.

The laser holder 332 differs in shape between the light-emitting modules 30Y, 30K and the light-emitting modules 30C, 30M. That is, each laser holder 332 (bracket 33) of the light-emitting modules 30K, 30Y placed on the upper side, out of the light-emitting modules 30Y, 30C, 30M, 30K placed in array in the up/down direction has an annular portion 332a. The annular portion 332a is formed in an annular shape protruding from an outer circumferential surface of the laser holder 332 (bracket 33). The annular portion 332a is arrayed in plurality in the outgoing direction (A direction) of the laser beam. Formation of the annular portion 332a makes it possible to form the laser holder 332 (bracket 33) with a larger outermost diameter while suppressing generation of any ingot piping in resin molding of the laser holder 332 (bracket 33).

By virtue of the formation of the annular portion 332a, an outermost diameter D2 of the laser holders 332 (brackets 33) of the light-emitting modules 30K, 30Y placed on the upper side, out of the light-emitting modules 30Y, 30C, 30M, 30K placed in array in the up/down direction, is larger than an outermost diameter D1 of the laser holders 332 (brackets 33) of the light-emitting modules 30C, 30M placed on the lower side (see FIG. 1). It is noted that the outermost diameters D1, D2 are outermost diameters measured in regions of the laser holders 332 (brackets 33) where later-described adhesive 95 is applied (regions interposed between the protruding portions 90, 91 or between the protruding portions 91, 92).

### (4. Fixation Method for Light-Emitting Modules)

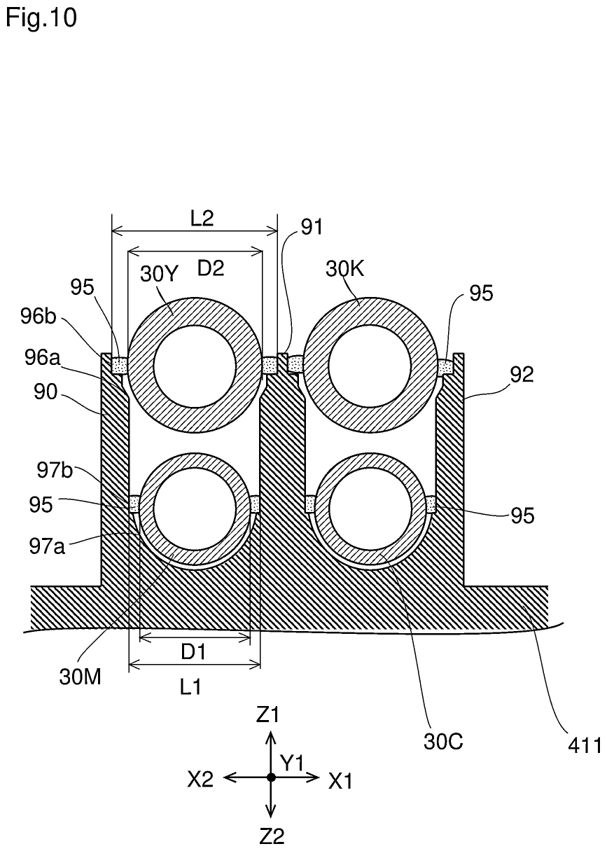

FIG. 10 is a sectional view perpendicular to the main scanning direction (Y1-Y2 direction) of the light source unit 46. The bottom wall portion 481a of the container portion 481 has protruding portions 90, 91, 92 protruding upward (Z1 direction) from the upper face (see FIG. 3). In this embodiment, the protruding portions 90, 91, 92 each have a plane perpendicular to the left/right direction (X1-X2 direction), and are placed in array in the left/right direction (X1-X2 direction). As viewed from the polygon mirror 45 in the main scanning direction (Y1-Y2 direction), the protruding portion 91 is placed at a position overlapping with a rotational axis J, and the protruding portion 90 is placed leftward (X2 direction) of the protruding portion 91. The protruding portion 92 is placed rightward (X1 direction) of the protruding portion 91.

The light-emitting modules 30Y, 30M are placed in array in the up/down direction (Z1-Z2 direction) between the neighboring protruding portions 90, 91, while the bracket 33 is fixed to both-side protruding portions 90, 91 via the adhesive 95. The light-emitting modules 30K, 30C are placed in array in the up/down direction (Z1-Z2 direction) between the neighboring protruding portions 91, 92, while the bracket 33 is fixed to both-side protruding portions 91, 92 via the adhesive 95.

The adhesive 95 is, for example, made from ultraviolet curable resin. As a result of this, the light-emitting modules 30Y, 30C, 30M, 30K, after adjusted in position, can be easily fixed to the protruding portions 90, 91, 92.

Since the light-emitting modules 30Y, 30C, 30M, 30K are fixed directly to the protruding portions 90, 91, 92 via the adhesive 95, fixation of the light-emitting modules 30Y, 30C, 30M, 30K can be easily attained while adjusting their orientations. As a result of this, orientations of the laser beams D1 to D4 emitted from the light-emitting modules 30Y, 30C, 30M, 30K can be fine adjusted three-dimensionally in the left/right direction (X1-X2 direction), front/rear direction (Y1-Y2 direction) and up/down direction (X1-X2 direction). As a result of this, positions of optical axes of the laser beams D1 to D4 can be adjusted.

Also, light-condensing position in the sub scanning direction for the deflection plane of the polygon mirror 45 can be adjusted by moving the light-emitting modules 30Y, 30C, 30M, 30K in the front/rear direction (Y1-Y2 direction) along the outgoing direction (A direction) of the laser beams D1 to D4.

Further, the optical axes of the laser beams D1 to D4 can be adjusted by circumferentially rotating the light-emitting modules 30Y, 30C, 30M, 30K about the optical axes extending in the outgoing direction (A direction) of the laser beams D1 to D4.

As to the coupling lens 32, its refractive index may be subject to variations due to temperature variations in its metal molding process, leading to a possibility that the light condensing position for the deflection plane of the polygon mirror 45 may be shifted. In this case, the light condensing position for the deflection plane of the polygon mirror 45 can be adjusted to a proper position by fine adjusting and fixing the position and orientation of the light-emitting modules 30Y, 30C, 30M, 30K. Accordingly, the light-emitting modules 30Y, 30C, 30M, 30K can be easily adjusted in position and fixed to proper positions, respectively.

Further, as described above, the laser holder 332 and the element holder 333 can be fixed via adhesive at specified positions with their orientations three-dimensionally changed mutually. Therefore, before adjustment of the orientations of the light-emitting modules 30Y, 30C, 30M, 30K, the light condensing position for the deflection plane of the polygon mirror 45 can be adjusted to a proper position by adjusting positional relationships between the laser holder 332 and the element holder 333.

The positional adjustment of the light-emitting modules 30Y, 30C, 30M, 30K is fulfilled by, for example, checking the position of optical axes and the beam diameter in the main scanning direction under a condition that the polygon mirror 45, the first scanning lens 41, the second scanning lens 42, and the reflecting mirrors 49a, 49b, 49c are fixed to the container portion 481. As a result of this, it is practicable to make parallel light securely incident on the first scanning lens 41 and moreover make the light condensing position in the main scanning direction adjusted to a proper position. Furthermore, it is also allowable to carry out positional adjustment for the light-emitting modules 30Y, 30C, 30M, 30K while checking laser beams formed into images on the surfaces of the photosensitive drums 1a to 1d by means of camera.

A width L2 between the protruding portions 90, 91 in a region where the light-emitting module 30Y placed on the upper side is interposed therebetween is larger than another width L2 between the protruding portions 90, 91 in a region where the light-emitting module 30M placed on the lower side is interposed therebetween. More specifically, a maximum width L2 in an upper end portion between the protruding portions 90, 91 where the light-emitting module 30Y placed on the upper side out of the light-emitting modules 30Y, 30C, 30M, 30K placed in array in the up/down direction is fixed is larger than a maximum width L1 at a lower end portion between the protruding portions 90, 91 where the light-emitting modules 30M placed on the lower side are fixed. In addition, similarly, a maximum width at an upper end portion between the protruding portions 91, 92 where the light-emitting module 30K is fixed is larger than a maximum width at a lower end portion between the protruding portions 91, 92 where the light-emitting module 30C placed on the lower side is fixed.

In more detail, at the upper end portion and the lower end portion between the protruding portions 90, 91, opposite faces opposed to each other in the left/right direction (X1-X2 direction) have curved portions 96a, 97a and recessed portions 96b, 97b. The curved portions 96a, 97a are each formed so as to be curved along the shape of the bracket 33. The recessed portion 96b is formed such that above the curved portion 96a, opposite faces of the protruding portions 90, 91 are recessed further outward in the left/right direction (X1-X2 direction). The recessed portion 97b is formed such that above the curved portion 97a, opposite faces of the protruding portions 90, 91 are recessed further outward in the left/right direction (X1-X2 direction). A width L2 of the recessed portion 97b in the left/right direction (X1-X2 direction) is larger than a width L1 of the recessed portion 97b in the left/right direction (X1-X2 direction). In this embodiment, the adhesive 95 is placed within the recessed portions 96b, 97b.

In this case, an outermost diameter D2 of the laser holders 332 (brackets 33) in the light-emitting modules 30K, 30Y placed on the upper side is larger than an outermost diameter D1 of the laser holders 332 (brackets 33) in the light-emitting modules 30C, 30M placed on the lower side. As a result of this, clearances between the laser holders 332 (brackets 33) and the protruding portions 90, 91, 92 can be uniformized in the light-emitting modules 30Y, 30C, 30M, 30K placed on the upper and lower sides. Accordingly, nonuniformities in thickness of the adhesive 95 intervening in clearances between the laser holders 332 (brackets 33) and the protruding portions 90, 91, 92 can be reduced. As a result of this, the light-emitting modules 30Y, 30C, 30M, 30K can be stably fixed after making their positional adjustment.

Also in this embodiment, the width L1 of the recessed portion 97b in the left/right direction (X1-X2 direction) is larger than the outermost diameter D1 in the region where the laser holders 332 (brackets 33) are in contact with the adhesive 95. As a result of this, the light-emitting modules 30M, 30C are unlikely to come into contact with the protruding portions 90, 91, 92 in making fine adjustment of their orientations. Thus, adjustable movable regions of the light-emitting modules 30C, 30M can be enlarged.

Similarly, the width L2 of the recessed portion 96b in the left/right direction (X1-X2 direction) is larger than the outermost diameter D2 in the region where the laser holders 332 (brackets 33) are in contact with the adhesive 95. Thus, adjustable movable regions of the light-emitting modules 30K, 30Y can be enlarged.

In addition, the present disclosure is not limited to the above-described embodiments, and may be changed and modified in various ways unless those changes and modifications depart from the gist of the disclosure. For example, under the condition that the bracket 33 in light-emitting modules placed on the upper and lower sides is identical in shape to the embodiments, the laser beams D1 to D4 emitted from the light-emitting modules 30Y, 30C, 30M, 30K are not particularly limited in terms of color order. For example, laser beams of C (cyan) or M (magenta) may be emitted from the light-emitting modules on the upper side.

The present disclosure is applicable to optical scanning devices in which latent images are formed on scanning-object surfaces by exposure scanning.

What is claimed is:

1. An optical scanning device comprising:
a light source unit having a plurality of light-emitting modules for each emitting a laser beam;
a polygon mirror which is rotated about a rotational axis extending in an up/down direction to reflect the laser beam emitted from the light source unit and make a circumferential surface of an image carrier scanned in a main scanning direction;
a first scanning lens for condensing the laser beam reflected by the polygon mirror;
a second scanning lens for making the laser beam, which has passed through the first scanning lens, form an image on the circumferential surface of the image carrier; and
a container unit for containing the light source unit, the polygon mirror, the first scanning lens, and the second scanning lens, wherein
each of the light-emitting modules includes;
a light-emitting element for emitting the laser beam;
a coupling lens for converting the laser beam emitted from the light-emitting element into a direction generally parallel to the main scanning direction and moreover condensing the laser beam to a sub scanning direction; and
a cylindrical-shaped bracket which extends in an outgoing direction of the laser beam to hold the coupling lens inside, and
the container unit includes:
a bottom wall portion extending in a direction perpendicular to the rotational axis; and
a plurality of protruding portions which protrude upward from an upper face of the bottom wall portion, and
the light-emitting modules are placed in array in the up/down direction between neighboring ones of the protruding portions,
an outermost diameter of the bracket in a region interposed between the protruding portions of the light-emitting modules placed on an upper side is larger than an outermost diameter of the bracket in a region interposed between the protruding portions of the light-emitting modules placed on a lower side, and
a width between the protruding portions in a region where the light-emitting modules placed on the upper side are interposed therebetween is larger than a width between the protruding portions in a region where the light-emitting modules placed on the lower side are interposed therebetween.

2. The optical scanning device according to claim 1, wherein
the bracket of light-emitting modules placed on the upper side out of the light-emitting modules placed in array in the up/down direction has an annular portion protruding from an outer circumferential surface and formed into an annular shape, the annular portion being provided in plurality so as to be arrayed in an outgoing direction of the laser beam.

3. The optical scanning device according to claim 1, wherein
the bracket is fixed to the protruding portions on both sides via adhesive.

4. The optical scanning device according to claim 3, wherein
the adhesive is made from ultraviolet curable resin.

5. An image forming apparatus comprising:
the optical scanning device according to claim 1;
the one or more image carriers on which a photosensitive layer is formed on its surface, and
a charging unit for electrically charging the image carrier to a specified surface potential, wherein
the optical scanning device exposes to light the surface of the image carrier charged by the charging unit to form an electrostatic latent image with charging level attenuated.
